(19) United States
(12) Patent Application Publication
(10) Pub. No.: US 2024/0234816 A9
(43) Pub. Date: Jul. 11, 2024

(54) FUNCTIONAL INTERPHASE STABILIZER FOR BATTERY ELECTRODES

(71) Applicant: NATRION INC., ALBANY, NY (US)

(72) Inventors: ALEXANDER KOSYAKOV, Champaign, IL (US); SOHEIL MALEKPOUR, Champaign, IL (US); DIPOBRATO SARBAPALLI, Brunswick, OH (US); DAH-SHYANG TSAI, Champaign, IL (US); CONNOR KNIAZ, Champaign, IL (US)

(21) Appl. No.: 18/492,229

(22) Filed: Oct. 23, 2023

Related U.S. Application Data
(60) Provisional application No. 63/380,889, filed on Oct. 25, 2022.

(51) Int. Cl. H01M 10/0569; H01M 10/0525; H01M 10/0568

(52) U.S. Cl. CPC H01M 10/0569; H01M 10/0525; H01M 10/0568; H01M 2300/0028

(57) ABSTRACT

The disclosure relates to a functional interphase stabilizer for a battery having an organic nonaqueous solvent and a lithium salt in solution with the organic nonaqueous solvent. The disclosure also relates to a battery having an anode, a cathode, a separator, a functional interphase stabilizer having an organic nonaqueous solvent, and a lithium salt in solution with the organic nonaqueous solvent. The disclosure also relates to a method of making a functional interphase stabilizer including the steps of providing an organic nonaqueous solvent, adding a lithium salt to the organic nonaqueous solvent, and mixing the organic nonaqueous solvent and the lithium salt to form a solution.

### CROSS REFERENCE TO RELATED APPLICATIONS

This patent application claims priority to U.S. Provisional Patent Application 63/380,889 filed on Oct. 25, 2022, the entirety of which is incorporated herein by reference.

### GOVERNMENT ASSISTANCE

In accordance with 35 U.S.C. § 202(c)(6), Applicant hereby states that the invention disclosed in this specification was made with United States of America Federal Government support (the Department of Defense, contract number N6893622C00180) and the United States of America Federal Government has certain rights in the invention.

### TECHNICAL FIELD

The present teachings relate to the use of a liquid functional interphase stabilizer which mediates the formation of stable solid electrolyte and cathode electrolyte interphases in lithium rechargeable batteries, and which may serve the purpose of a liquid electrolyte in a lithium rechargeable cell or be used with a solid-state electrolyte.

### BACKGROUND

Electrification of mobility sectors such as the automotive and aviation industries demands energy storage devices with high gravimetric and volumetric energy density, reasonable charging speed capability, high charge/discharge cycle life, low cost, and high thermal and mechanical abuse stability.

Although lithium-ion batteries (LIBs) have found extensive use in consumer electronics and electric vehicles, they continue to face safety and performance-related shortcomings. These limitations can be traced back to the organic liquid electrolytes (LEs) that LIBs rely upon.

Prevailing LIB designs typically implement LE-soaked separators made of polyethylene (PE), polypropylene (PP), or a PE/PP composite blend. The LEs tend to be approximately 1 molar solutions of lithium hexafluorophosphate (LiPF₆) in mixtures of ethylene carbonate (EC), ethyl methyl carbonate (EMC), diethyl carbonate (DEC), dimethyl carbonate (DMC), and other organic solvents. These solvents decompose at different electrochemical potentials on the surfaces of the electrodes, resulting in the formation of different radicals or ions that then react consecutively to create several compounds. These compounds gradually develop into a hybrid layer of organic and inorganic materials that deposit on the electrode sites due to their high surface energy, leading to the development of solid electrolyte interphase (SEI) and cathode electrolyte interphase (CEI) films at the interfaces of the anode materials/cathode materials and the separator. Both SEI and CEI films play an important role in cyclic stability, coulombic efficiency, rate capability and safety.

Li-metal batteries (LMBs), which use metallic lithium as their anode instead of graphitic carbons like LIBs, have the potential to deliver greatly improved energy density performance characteristics. Unfortunately, Li-metal anode (LMA) exacerbates the negative effects of SEI generation. Although LMAs have a theoretical specific capacity of over 3000 mAh g⁻¹ (compared to conventional graphite anodes with a theoretical specific capacity of 370 mAh g⁻¹), LMAs' surfaces are highly reducing and rapidly decompose LE into SEI products. With each charge/discharge cycle of an LMB cell the LMA consumes more LE and converts it into SEI. This continuous growth leads to an unfavorably thick SEI layer, which increases the internal impedance of the LMB cell and contributes to cycle life degradation via increased polarization. The successive growth of additional SEI also removes cyclable lithium from the cell system and converts it into nonreversible SEI products. This phenomenon also degrades cell capacity with each cycle.

Furthermore, the SEI layer can be mechanically unstable and crack, which can lead to the exposure of bare lithium metal surfaces that are not protected by the SEI film. Lithium dendrites can form on these bare interfaces. Dendritic growth may puncture a cell's separator and cause an internal short-circuit. The rapid increase in temperature accompanied by this failure mode can trigger battery fire/explosion via vaporization of the LE. A stable SEI layer is crucial to prevent the formation of these adverse lithium dendrites and improve the long-term cyclic stability of the battery.

Given the SEI's crucial role in the performance of LMBs, the battery industry has experienced a recent rise in efforts to improve SEI dynamics of LMAs. New methods include the use of solid-state electrolytes (SSEs) that are more thermally and electrochemically stable than LEs. Properly engineered SSEs' enhanced resilience mitigates runaway SEI growth as they cannot be reduced by LMA. They are also less readily converted into combustible gaseous products.

SSEs are commonly composed of ceramic, polymer, or a composite of materials. While ceramic materials offer similar ionic conductivity to LEs, they are challenging to synthesize, handle, and implement at scale in LIBs and serial-production LMBs. On the other hand, SSEs made of polymer materials possess excellent mechanical attributes and can be more easily integrated into existing cell production equipment, but they tend to have limitations in achieving rapid ion transport at room temperature.

Moreover, ceramic-based SSEs, while exhibiting high bulk ion transport performance, suffer from high resistivity at their interfaces with electrodes. A common strategy to circumvent interfacial resistance is to use stack pressure. Uniaxial compression of the cell stack has been repeatedly shown to not only lower internal cell resistance but contribute to highly efficient Li plating/stripping on LMA characterized with high coulombic efficiency and cyclable lithium retention and low polarization growth. However, excessive external uniaxial compression (>5 atm) invariably requires the placement of cells in mechanical clamping devices. Such devices contribute mass and volume that erode the energy density gains of LMBs.

In summary, there is a need to develop solutions to promote robust SEI formation that address and overcome above-mentioned problems in the art.

### SUMMARY

The following is a summary providing an initial understanding of the teachings herein. The summary does not necessarily identify key elements nor limit the scope of the teachings, but merely serves as an introduction to the following description.

One aspect of the present teachings provides an LIB or LMB having a dense active solid-state electrolyte separator or a porous inactive separator and a functional interphase stabilizer (FIS).

The present teachings provide LIBs or LMBs having a porous separator or dense SSE separator and a FIS. The FIS stabilizes the interface between the anode electrode and the separator by forming an SEI during formation cycling of the cell. The FIS-composed SEI is durable and uses minimal cyclable lithium. This enhances the coulombic efficiency of the cell in subsequent cycles and contributes to improved cycling stability and cycle life. In the process, most of the FIS is reduced into solid-state SEI products with limited residual liquid FIS being left behind. This means that after formation cycling the volume of liquid inside of an FIS-using cell is diminished and volatilizable phases are minimized.

The FIS forms a stable SEI on the anode surface, which is mechanically adhered to the porous PE/PP or dense SSE separator. This prevents the SEI from cracking from volumetric dynamism of the anode active material during lithiation/delithiation. Such dynamism is especially problematic for LMA, which may exhibit 300% volumetric expansion during charging and discharging, or silicon-based anodes which expand as much as 400%. The thin, flexible SEI produced by FIS thus further supports improved cycle life. The simultaneous adhesion to the anode and separator also supports low resistivity of the electrolyte/SEI and SEI/anode interfaces. This low resistivity is maintained even at low stack pressures (for example, from 0 to 3.4 atm of external uniaxial compression of the cell stack) and with a solid-state electrolyte separator.

The addition of FIS at the interface between the cathode electrode and a separator also improves the battery's current density capability. The FIS reduces the interfacial resistance between the cathode and electrolyte, which allows for higher charge and discharge current densities (for example, ≥4 mA cm⁻²) with lower polarization. CEIs derived from FIS decomposition on cathodes can protect the separator from the high oxidative activity of high-performance cathode materials with high specific surface area and nickel content, for example. The CEI may also prevent the dissolution of transition metals such as manganese from manganese-containing spinel and transition metal oxide cathode materials. Manganese ion dissolution from these active materials and their migration to the anode, where they take part in parasitic side reactions, is known as “electrode crosstalk” and is another mechanism that may detrimentally affect cycling stability of advanced lithium secondary cells.

In one aspect, the present teachings provide a battery including an anode comprised of active material based on graphitic carbon, metalloid (such as, for example, silicon, silicon oxide, or a silicon-carbon composite), lithium-metal or a composite containing two or more of these materials.

In one aspect, the present teachings provide a battery including a cathode comprised of spinel, olivine, or transition metal oxide based active material.

In one aspect, the present teachings provide a battery including a separator made of porous polyolefin, such as polyethylene, polypropylene, or a composite of these, or a dense solid-state electrolyte comprising a ceramic or polymer or a composite of these.

In one aspect, the present teachings provide a battery including a FIS comprised of at least one organic solvent and at least one dissolved lithium salt.

In one aspect, the present teachings provide a battery where the FIS can be wetted onto the separator or the electrodes before or during the battery assembly process, or it can be injected into the battery after it is assembled. The FIS can be used in batteries of any size or shape, including coin cells and pouch cells.

In one aspect of this disclosure, a FIS for a battery is provided having an organic nonaqueous solvent and a lithium salt in solution with the organic nonaqueous solvent.

In another aspect of this disclosure, the lithium salt has a concentration in solution of about 0.1M to about 8M.

In another aspect of this disclosure, the organic nonaqueous solvent includes at least one of 1,2-Dimethoxyethane (DME), 1,1,2,2-Tetrafluoroethyl-2,2,3,3-tetrafluoropropyl ether (TTE), Dimethyl sulfide (DMS), Fluoroethylene carbonate (FEC), Dimethyl sulfoxide (DMSO), Dimethyl methylphosphonate (DMMPh), Trimethyl phosphate (TMP), Tris(trimethylsilyl) phosphite (TMSPi), Dioxolane (DOL), 1,1-Diethoxyethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

In another aspect of this disclosure, the lithium salt includes at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO3), Lithium difluoro(oxalato)borate (LiDFOB), Lithium iodide (LiI), Lithium Difluorophosphate (LiPO2F2), or Lithium hexafluorophosphate (LiPF6).

In another aspect of this disclosure, a battery is provided having an anode, a cathode, a separator, a functional interphase stabilizer having an organic nonaqueous solvent, and a lithium salt in solution with the organic nonaqueous solvent;

In another aspect of this disclosure, the lithium salt has a concentration in solution of about 0.1M to about 8M.

In another aspect of this disclosure, the nonaqueous solvent includes at least one of 1,2-Dimethoxyethane (DME), 1,1,2,2-Tetrafluoroethyl-2,2,3,3-tetrafluoropropyl ether (TTE), Dimethyl sulfide (DMS), Fluoroethylene carbonate (FEC), Dimethyl sulfoxide (DMSO), Dimethyl methylphosphonate (DMMPh), Trimethyl phosphate (TMP), Tris(trimethylsilyl) phosphite (TMSPi), Dioxolane (DOL), 1,1-Diethoxyethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), or Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

In another aspect of this disclosure, the lithium salt includes at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO₃), Lithium difluoro(oxalato)borate (LiDFOB), Lithium iodide (LiI), Lithium Difluorophosphate (LiPO₂F₂), or Lithium hexafluorophosphate (LiPF₆).

In another aspect of this disclosure, the battery further includes a solid electrolyte interphase on the anode surface.

In another aspect of this disclosure, the solid electrolyte interphase on the anode surface is mechanically adhered to the separator.

In another aspect of this disclosure, the battery further includes a cathode electrolyte interphase on the cathode surface.

In another aspect of this disclosure, the cathode electrolyte interphase on the cathode surface is mechanically adhered to the separator.

In another aspect of this disclosure, the separator is selected from the group consisting of a polymer membrane or a multilayered film of polyethylene, polypropylene, polyolefin, a microporous film, ethylene/butene copolymer, ethylene/hexene copolymer, ethylene/methacrylate copolymer, woven fabric, woven fabric with glass fiber, woven fabric with polyethylene terephthalate fiber, cellulose, aramid fiber, another organic or synthetic fiber, ceramic, composite polymer-ceramic solid-state electrolyte, or a combination thereof. The separator may as well possess a functional polymer and/or ceramic coating that enhances its thermal and/or mechanical properties.

In another aspect of this disclosure, the cathode is selected from a group consisting of lithium cobalt-phosphate (LiCoPO₄), lithium iron-phosphate (LiFePO₄), and lithium metal oxide (LiMeOₓ) wherein Me is one or more metal selected from the group consisting of nickel (Ni), cobalt (Co), manganese (Mn) aluminum (Al), Li and O represent one or more respective lithium and oxygen atoms, and x represents the number of oxygen atoms. For example, LiNi_{0.8}Mn_{0.1}Co_{0.1}O₂ (NMC811) is often chosen as a favorable cathode active material. The cathode may also be selected from a group consisting of any other suitable spinel, olivine, sulfide, selenide, halide, or a combination thereof containing or not containing lithium.

In another aspect of this disclosure, the anode is selected from the group consisting of a carbon-based anode active material, graphitic carbon, carbon fibers, a tin oxide compound, silicon oxide, silicon metal, and silicon-carbon composite, a lithium-metal, a lithium alloy, or a combination thereof.

In another aspect of this disclosure, a method is provided for making a functional interphase stabilizer having the steps of providing an organic nonaqueous solvent, adding a lithium salt to the organic nonaqueous solvent, and mixing the organic nonaqueous solvent and the lithium salt to form a solution.

In another aspect of this disclosure, the method includes the steps of adding an additive to the solution and mixing the solution until the additive is dissolved or homogenized.

In another aspect of this disclosure, the additive is a secondary salt.

In another aspect of this disclosure, the method includes the step of adding a diluent to the solution and mixing the solution until the diluent is homogenized.

In another aspect of this disclosure, the diluent is a secondary solvent.

These additional, and/or other aspects and/or advantages of the present disclosure are set forth in the detailed description which follows; possibly inferable from the detailed description; and or learnable by practice of the present disclosure.

Other features and aspects of the present teachings will become apparent from the following detailed description, taken in conjunction with the accompanying drawings, which illustrate by way of example the features in accordance with embodiments of the present teachings. The summary is not intended to limit the scope of the present teachings.

### BRIEF DESCRIPTION OF THE DRAWINGS

FIG. 1 is a flow diagram illustrating the production of a Functional Interphase Stabilizer (FIS).

FIG. 2 is a schematic of a coin cell cross section.

FIG. 3 is an image of a pouch cell.

FIG. 4 is an equivalent circuit for determining the electrochemical impedance of cells, where R_{L} is proportional to the ionic conductivity (itself a function of the ionic conductivity of the FIS, electrolyte, and separator), R_{ct} is representative of the charge-transfer resistance, C_{dl} is a capacitor corresponding to double-layer capacitance, and W is a Warburg element which models diffusion impedance.

FIGS. 5A and 5B are Nyquist plots generated from electrochemical impedance spectroscopy of 2-layer 96 mAh pouch cells assembled with NMC811 cathode and Li-metal anode with (i) traditional carbonate electrolyte consisting of 1.2M LiPF₆ in 3:7 (w/w) ethylene carbonate (EC)/ethyl methyl carbonate (EMC) with PE/PP separator and (ii) FIS with dense polymer-ceramic composite solid-state electrolyte separator, respectively. The pouch cells were at 2.25 atm of external uniaxial stack compression and room temperature and the EIS was measured in 1 MHz to 0.1 Hz after the cells had completed formation cycling. The lower x-intercept of the FIS cells indicates a lower R_{L} (higher ionic conductivity) and the smaller diameters of the semicircle portions of the FIS spectra as compared to the carbonate electrolyte spectra indicates a lower R_{ct} (charge-transfer resistance).

FIGS. 6A and 6B shows the discharge capacity retention and cycling coulombic efficiency of a 3.58 mAh coin cell made with NMC811 cathode, 250 μm-thick LMA, and FIS paired with a dense polymer-ceramic composite solid-state electrolyte separator symmetrically charged and discharged at 4 mA cm⁻² at room temperature between 3V and 4.2V.

FIGS. 7A, 7B, and 7C show charge (circle in FIG. 7A/increasing slope in FIG. 7C) and discharge (square in FIG. 7A/decreasing slope in FIG. 7C) specific capacity (normalized for cathode active material mass), cycling coulombic efficiency, and capacity/voltage curves of a 96 mAh 2-layer pouch cell made with NMC811 cathode, 20 μm-thick LMA, and 1.2M LiPF₆ in 3:7 (w/w) ethylene carbonate (EC)/ethyl methyl carbonate (EMC) with PE/PP separator at room temperature with 0 atm of external uniaxial compression. The charging consisted of constant current charging to 4.25V at 0.67 mA cm⁻² with constant voltage charging at 4.25V to a 0.1 mA cm⁻² cutoff and constant current discharge to 2.5V at 0.67 mA cm⁻².

FIGS. 8A, 8B, and 8C show charge (circle in FIG. 8A/increasing slope in FIG. 8C) and discharge (square in FIG. 8A/decreasing slope in FIG. 8C) specific capacity (normalized for cathode active material mass), cycling coulombic efficiency, and capacity/voltage curves of a 96 mAh 2-layer pouch cell made with NMC811 cathode, 20 μm-thick LMA, and FIS with PE/PP separator at room temperature with 0 atm of external uniaxial compression. The charging consisted of constant current charging to 4.25V at 0.67 mA cm⁻² with constant voltage charging at 4.25V to a 0.1 mA cm⁻² cutoff and constant current discharge to 2.5V at 0.67 mA cm⁻².

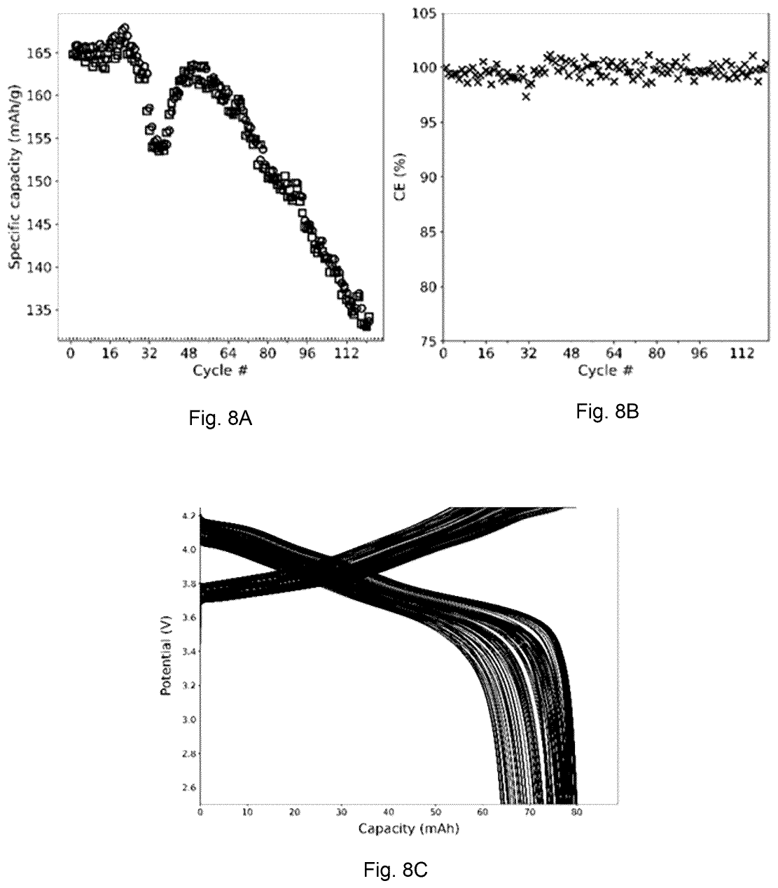

FIGS. 9A, 9B, 9C show charge (circle in FIG. 9A/increasing slope in FIG. 9C) and discharge (square in FIG. 9A, decreasing slope in FIG. 9C) specific capacity (normalized for cathode active material mass), cycling coulombic efficiency, and capacity/voltage curves of a 96 mAh 2-layer pouch cell made with NMC811 cathode, 20 μm-thick Li-metal anode LMA, and FIS with dense polymer-ceramic composite solid-state electrolyte separator at room temperature with 0 atm of external uniaxial compression. The charging consisted of constant current charging to 4.25V at 0.67 mA cm⁻² with constant voltage charging at 4.25V to a 0.1 mA cm⁻² cutoff and constant current discharge to 2.5V at 0.67 mA cm⁻².

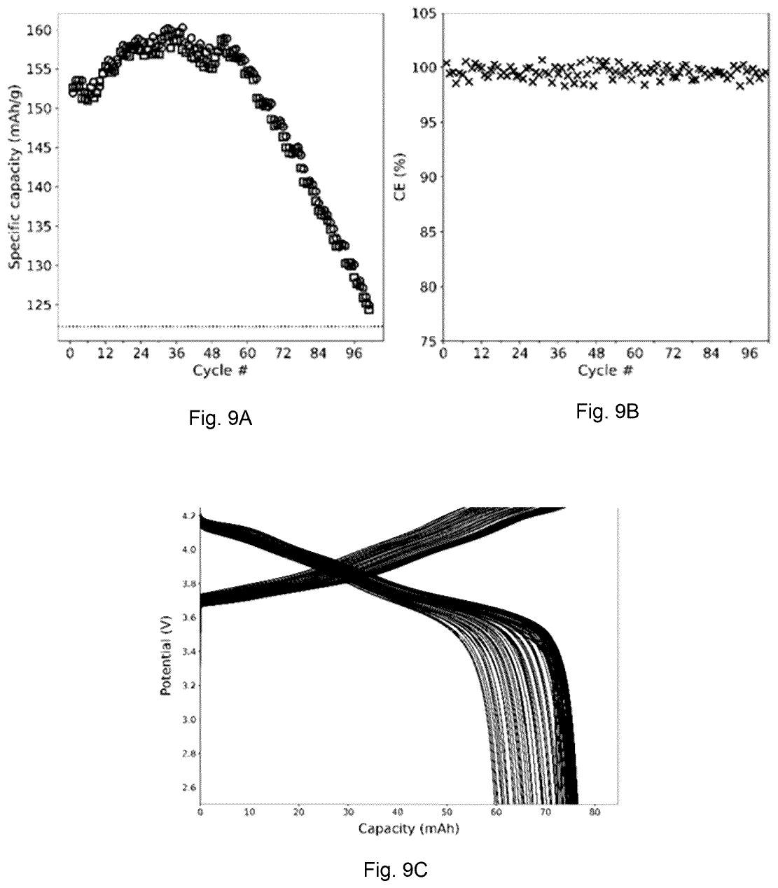

FIGS. 10A and 10B show discharge capacity retention and cycling coulombic efficiency of a 48 mAh 1-layer pouch cell made with NMC811 cathode, 20 μm-thick LMA, and FIS paired with a porous PE/PP separator at room temperature with 3.4 atm of external uniaxial compression. The charging consisted of constant current charging to 4.2V at 0.4 mA cm⁻² with constant voltage charging at 4.2V to a 0.05 mA cm⁻² cutoff and constant current discharge to 3V at 1 mA cm⁻².

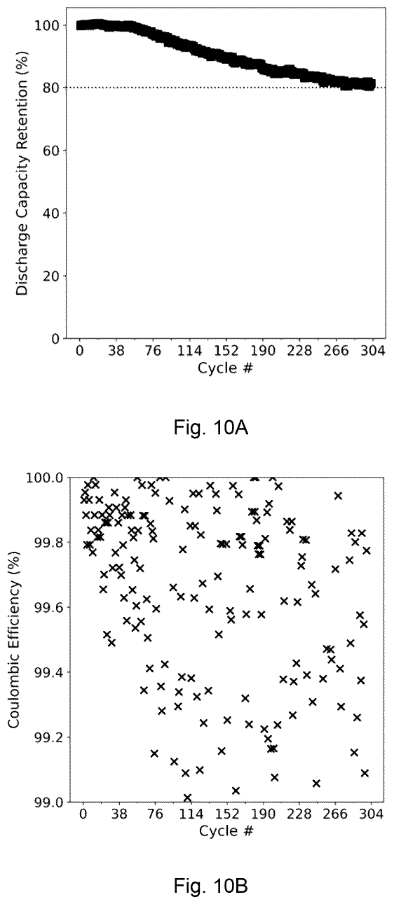

FIGS. 11A and 11B show discharge capacity retention and cycling coulombic efficiency of a 3.58 mAh coin cell made with NMC811 cathode, graphite anode, and a PE/PP separator symmetrically charged and discharged at 1 mA cm⁻² at room temperature. The charging consisted of constant current charging to 4.2V at 1 mA cm⁻² with constant voltage charging at 4.2V to a 0.1 mA cm⁻² cutoff and constant current discharge to 3V at 1 mA cm⁻².

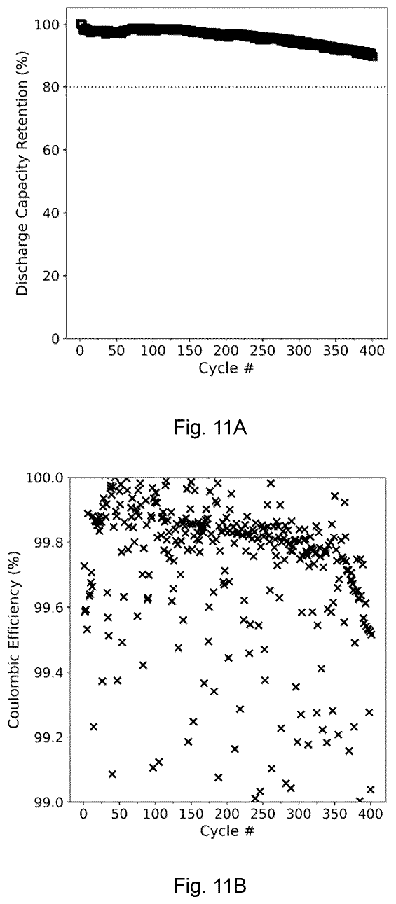

FIGS. 12A, 12B, and 12C show charge (circle in FIG. 12A, decreasing slope in FIG. 12C) and discharge (square in FIG. 12A, increasing slope in FIG. 12C) specific capacity (normalized for anode active material mass), cycling coulombic efficiency, and capacity/voltage curves of a 7.16 mAh coin cell made with SiOₓ-based (x being the number of oxygen atoms) anode, 250 μm-thick LMA as the counter electrode, and FIS with a PE/PP separator at room temperature. The cycling consisted of symmetric charging and discharging between 0.05V and 1V at 2 mA cm⁻².

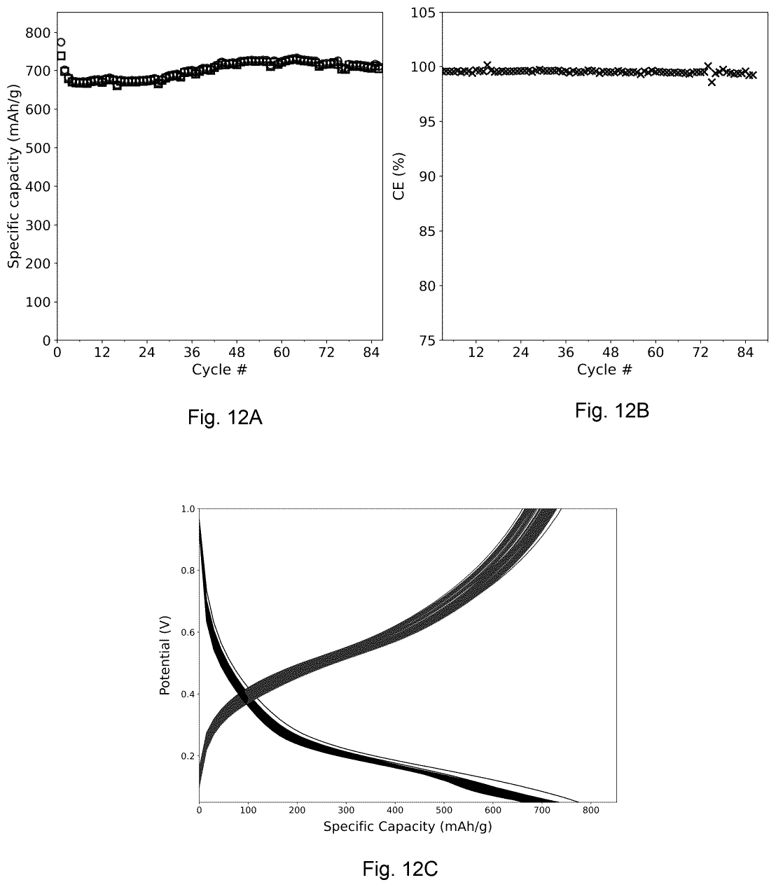

FIGS. 13A, 13B, 13C show charge (circle in FIG. 13A, decreasing slope in FIG. 13C) and discharge (square in FIG. 13A, increasing slope in FIG. 13C) specific capacity (normalized for anode active material mass), cycling coulombic efficiency, and capacity/voltage curves of a 7.16 mAh coin cell made with SiC-based anode, 250 μm-thick LMA as the counter electrode, and FIS with a porous PE/PP separator at room temperature. The cycling consisted of symmetric charging and discharging between 0.05V and 1V. Cycles 1-5 were completed with 0.8 mA cm⁻² current density, cycles 6-10 with 2 mA cm⁻², cycles 11-15 with 4 mA cm⁻², and cycles 16-20 at 0.8 mA cm⁻².

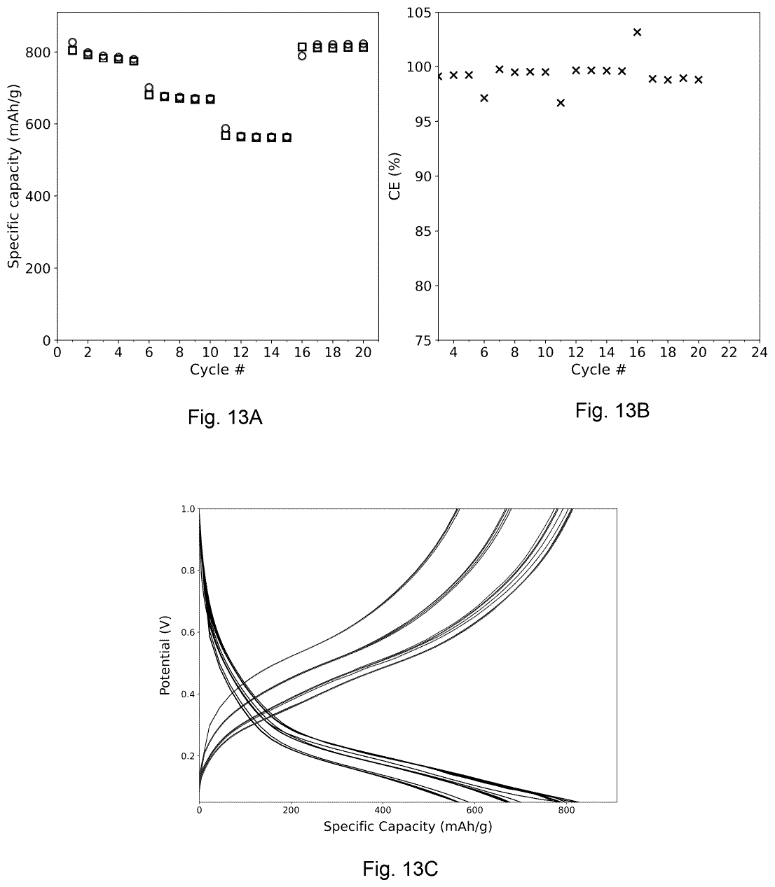

### DETAILED DESCRIPTION

The present teachings are described more fully hereinafter with reference to the accompanying drawings, which are part of this description, and in which the present embodiments are shown. The following description is presented for illustrative purposes only and the present teachings should not be limited to these embodiments.

In the following description, various aspects of the present disclosure are described. For purposes of explanation, specific configurations and details are set forth in order to provide a thorough understanding of the present disclosure. However, it will also be apparent to one skilled in the art that the present disclosure may be practiced without the specific details presented herein. Furthermore, well known features may have been omitted or simplified in order not to obscure the present disclosure. With specific reference to the drawings, it is stressed that the particulars shown are by way of example for purposes of illustrative discussion of the present disclosure only and are presented to show what is believed to be most useful and readily understood description of the principles and conceptual aspects of the disclosure. In this regard, no attempt is made to show structural details of the disclosure in more detail than is necessary for a fundamental understanding, the description taken with the drawings making apparent to those skilled in the art how the several forms of the disclosure may be embodied in practice.

Before the disclosure is explained in detail, it is to be understood that the disclosure is not limited in its application to the details of construction and the arrangement of the components set forth in the following description or illustrated in the drawings. The disclosure is applicable to other disclosure that may be practiced or carried out in various ways as well as to combinations thereof. Also, it is to be understood that the phraseology and terminology employed herein are for the purpose of description and should not be regarded as limiting.

The present teachings provide efficient and economical methods and mechanisms for improving the cycling lifetime of lithium rechargeable batteries and thereby provides improvements to the technological field or energy storage.

The present teachings are directed towards LIB cells, LMB cells, and functional interphase stabilizers (FISs) therefore. The FIS includes lithium salts and organic solvents that stabilize the solid-electrolyte interphase (SEI) at the surfaces of the anode materials particles, and/or the cathode electrolyte interphase (CEI) at the surface of the cathode material particles. The surface layer on the anode and/or cathode can be formed by mechanisms including the partial decomposition of the chemical substances present in the electrolyte composition. The lithium salt can be incorporated in the surface layer.

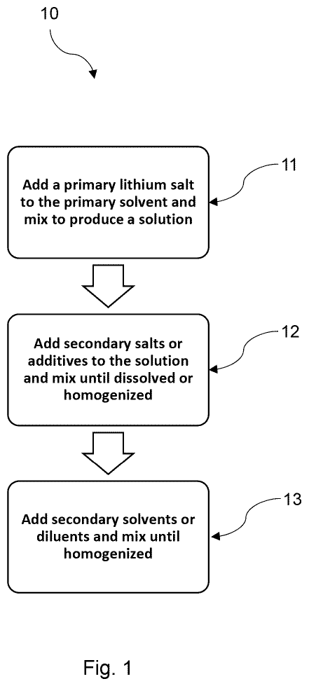

FIG. 1 shows a method 10 for producing FIS. First, in step 11, a primary lithium salt (for example, the salts discussed below) is added to the primary solvent (for example, the solvents discussed below) and mixed to produce a solution. In step 12, optional additives such as secondary salts (including any of the lithium salts discussed below, such as LiDFOB and LiNO₃, etc.) are added to the solution and mixed until dissolved or homogenized. At step 13, optional diluents such as secondary solvents (including any of the organic solvents discussed below, such as HFEs like TTE) are added to the solution and mixed until homogenized.

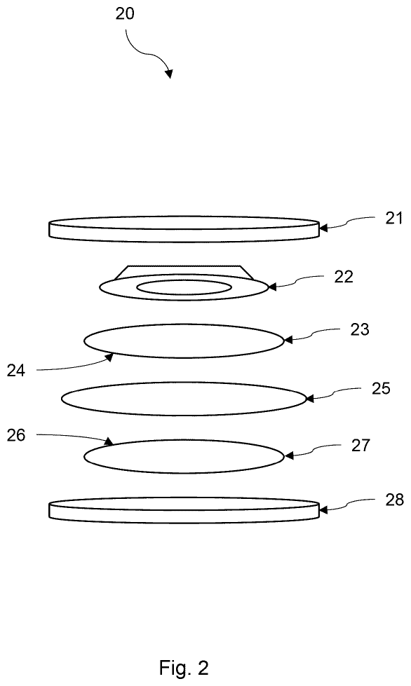

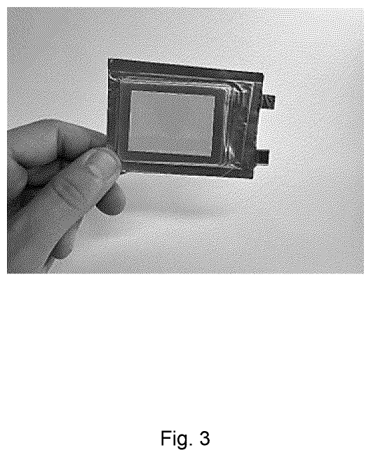

FIG. 2 shows a button cell battery 20. The button cell battery 20 has a negative case 21 and a positive case 28. A spring 22 sits next to the negative case 21. A separator 25 is sandwiched between an anode (negative electrode) 23 and a cathode (positive electrode) 27. Functional interphase stabilizers (FISs) 24, 26 are added to the surfaces of the anode 23 and cathode 27, respectively. The functional interphase stabilizers 24, 26 may be same or different. Functional interphase stabilizers 24, 26 may be added to the anode 23, the cathode 27, or both. While FIG. 2 shows a button cell battery 20, it is noted that the battery 20 can be provided as a pouch, such as shown in FIG. 3, or in other forms as will be understood by those skilled in the art.

The functional interphase stabilizers 24, 26 may include a source of lithium-ion mobility. Any lithium salt material commonly used in LE for LIBs may be used. The lithium salt may be representatively any one material or a mixture of at least two materials selected from the group consisting of:
a. Lithium bis(trifluoromethanesulfonyl)imide (LiTFSI),
b. Lithium bis(fluoromethanesulfonyl)imide (LiFSI),
c. Lithium fluoride (LiF),
d. Lithium nitrate (LiNO₃),
e. Lithium difluoro(oxalato)borate (LiDFOB),
f. Lithium iodide (LiI),
g. Lithium Difluorophosphate (LiPO₂F₂),
h. Lithium hexafluorophosphate (LiPF₆).

Lithium salt is preferably used in the concentration range of 0.1M to 8.0M. If the concentration of the lithium salt is less than 0.1M, the concentration is low, thereby reducing the performance of the stabilizer. On the other hand, if the concentration of the lithium salt is greater than 8.0M, the viscosity of the stabilizer increases, thereby reducing the mobility of lithium ions and degrading the performance at low temperatures.

The functional interphase stabilizers 24, 26 may include an organic solvent. Any ether- and carbonate-based material commonly used in an electrolyte of a lithium-ion rechargeable battery may be used. The organic compound may include as representative examples any one material or a mixture of at least two materials selected from the group consisting of:
Ethers, including:
   1,2-Dimethoxy ethane (DME), and/or
   1,1-Diethoxy ethane (DEE),
Hydrofluoroethers (HFEs), including:
   Methyl 1,1,2,2 tetrafluoroethyl ether (TFME), and/or
   1,1,2,2-tetrafluoroethyl-2,2,3,3-tetrafluoropropyl ether (TTE),
   1,2-(1,1,2,2-Tetrafluoroethoxy)ethane,
   1,1,2,2-Tetrafluoroethyl-1H,1H,5H-octafluoropentyl ether,
Fluorinated carbonates, including Fluoroethylene carbonate (FEC),
Organosulfurs, including:
   Dimethyl sulfide (DMS),
   Dimethyl sulfoxide (DMSO), and/or
   Sulfolane (SL),
Phosphates, including:
   Triethyl phosphate (TEP),
   Trimethyl phosphate (TMP),
   Dimethyl methylphosphonate (DMMPh), and/or
   Triphenyl phosphate (TPhP),
Phosphites, including Tris(trimethylsilyl) phosphite (TMSPi),
Cyclic ethers, including Tetrahydrofuran (THF),
Fluorinated ortho esters, including Tris(2,2,2-trifluoroethyl) orthoformate (TFEO),
Carbonates, including Vinylene carbonate (VC),
Nitriles, including Acetonitrile,
Methyl beta-L-fucopyranoside (MFB),
Other heterocyclic organic solvents, including Dioxolane (DOL).

Among the carbonate-based organic solvents, cyclic carbonates such as EC and PC may be preferably used since they have high viscosity such that they show high dielectric constants and thus dissociate lithium salts in the FIS. Also, if a linear carbonate with low viscosity and low dielectric constant such as DMC and EDC is mixed with a cyclic carbonate at a suitable ratio, it is possible to make an FIS with high electronic conductivity.

The FIS for an LIB or LMB is injected into an electrode structure having an anode 23, a cathode 27 and a porous inactive separator 25 or a dense active SSE separator 25 interposed between the anode 23 and the cathode 27, thereby making an LIB or LMB cell. The anode 23, the cathode 27 and a separator 25 may be from any kind of material commonly used in making a lithium-ion rechargeable battery, such as those discussed below.

A cathode 27 may be formed from a metal oxide, layered oxide, spinel, olivine, disordered rock salt, or other structure, which may be used for receiving Li ions through intercalation/deintercalation. More specifically, a cathode 27 active material may preferably be a lithium-containing transition metal oxide or phosphate, for example, any one material or a mixture of at least two materials selected from a group consisting of:
LiCoO₂,
LiNiO₂,
LiMnO₂,
LiMn₂O₄,
LiNi_{A}Mn_{B}Co_{C}O₂ (0<A<1, 0<B<1, 0<C<1, A+B+C=1),
LiNi_{A}Mn_{B}Co_{C}O₂ (0<A<2, 0<B<2, 0<C<2, A+B+C=2),
LiNi_{1-Y}Co_{Y}O₂ (0≤Y<1),
LiCo_{1-Y}Mn_{Y}O₂ (0≤Y<1),
LiNi_{1-Y}Mn_{Y}O₂ (0≤Y<1),
LiMn_{2-Z}Ni_{Z}O₄ (0<Z<2),
LiMn_{2-Z}Co_{Z}O₄ (0<Z<2),
LiCoPO₄, and
LiFePO₄.
   Also, sulfide, selenide and halide may be used in addition to the above oxides as dopants of the cathode active material. The cathode may contain a binding agent such as polyvinylidene fluoride (PVDF) and electronically conductive additives such as amorphous carbon or carbon nanotubes.

An anode 23 active material may be formed from carbon material, lithium metal, or a silicon-based material, which may be used to store Li ions through intercalation/deintercalation, formation of an intermetallic phase, direct deposition (plating/stripping), or a combination of these. Among them, carbon materials are the conventional choice. The carbon material may be low-crystallinity carbon or high-crystallinity carbon. The low-crystallinity carbon may be soft carbon or hard carbon, as representative examples, and the high-crystallinity carbon may be natural graphite, Kish graphite, pyrolytic carbon, mesophase pitch-based carbon fiber, meso-carbon microbeads, mesophase pitches, or high-temperature sintered carbon, such as petroleum or coal tar pitch derived cokes, as representative examples. The anode 23 may contain a binding agent, which may employ various kinds of binder polymers, such as PVDF, PVDF-co-hexfluoropropylene (HFP), polyacrylonitrile (PAN), polymethylmethacrylate (PMMA), polyacrylic acid (PAA), and carboxymethyl cellulose (CMC) with styrene-butadiene rubber (SBR).

In addition, the separator 25 may be formed of common porous polymer films such as, for example, porous polymer films made using ethylene homopolymer, propylene homopolymer, ethylene/butene copolymer, ethylene/hexene copolymer or ethylene/methacrylate copolymer, in a single layer or in laminate form. In other cases, the separator 25 may be formed of a woven fabric or a common porous non-woven fabric such as a non-woven fabric made of glass fiber with a high melting point or polyethylene terephthalate fiber, but it is limited thereto. The porous separator 25 may also be made of cellulose, aramid fiber, or another organic or synthetic fiber. The separator 25 may also be a composite polymer-ceramic solid-state electrolyte. The separator 25 may also have a functional ceramic or polymer coating that enhances its thermal, mechanical, and/or electrochemical stability.

Example 1 illustrates an exemplary process for the synthesis of a FIS. Example 2 illustrates an exemplary process for creation of a FIS.

### Example 1: Synthesis of FIS

The solution is formulated by employing 5 ml of solvent as a foundation. Initially, a vial is charged with 4.35 g of DME (5 ml). The solid additives are dissolved in DME solvent, followed by the introduction of 0.14 g of LiNO₃, resulting in the formation of a 0.4M LiNO₃ solution. To generate a 2M LiFSI salt solution, 1.871 g of LiFSI, serving as the predominant salt, is meticulously incorporated into the solution and extensively mixed. Subsequently, the solution is blended with sulfolane, employing a volumetric ratio of 1:1 with DME.

### Example 2: Synthesis of FIS

All concentration measurements and proportions are estimated on the undiluted solution mass and volume which contains no hydrofluoroether diluent. Initially, solid additives are subjected to dissolution. The solution is formulated by employing 5 ml of solvent as a foundation. Initially, a vial is charged with 4.35 g of DME (5 ml). Subsequently, 0.14 g of LiNO₃ is introduced to yield a 0.4M LiNO₃ solution in DME. Subsequent to this step, LiDFOB is incorporated into the solution, where the LiDFOB concentration constitutes 2 wt % of prior solution (LiFSI+LiNO₃+DME). The solution is subjected to agitation until complete dissolution of LiDFOB is achieved. Moreover, 1.871 g of LiFSI, serving as the primary salt, is added to the solution and thoroughly mixed to produce a 2M LiFSI salt solution. Following this stage, any liquid additives can be introduced. Specifically, 2 wt % VC (relative to LiFSI+DME+LiNO₃) is added to the solution and agitated for a duration of 5 minutes. Subsequently, the solution is diluted to half of its initial concentrations employing the appropriate volume (in this instance, 5 ml or 7.5 g) of TTE, in a 1:1 volume-to-volume ratio with DME.

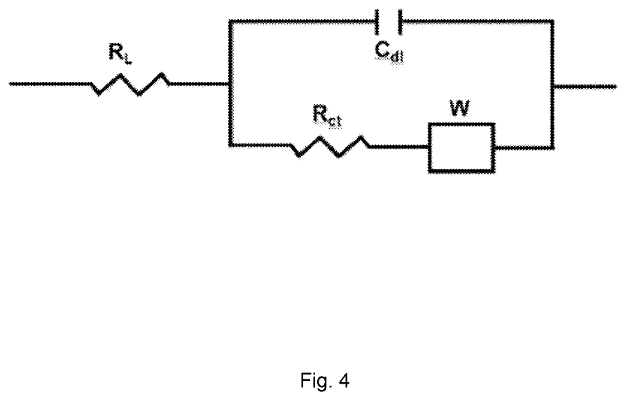

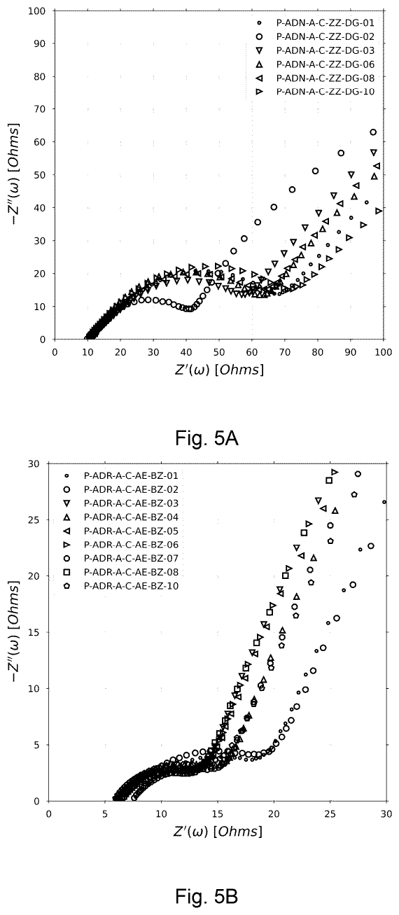

After the FISs, for example in Example 1 and Example 2, are made, their electrochemical performance and compatibility with electrodes and solid electrolyte or a separator is evaluated using Electrochemical Impedance Spectroscopy (EIS). The half-cell and full cell structure comprising an anode material, a cathode material, and an electrolyte material with the addition of a FIS, for example, as seen in FIG. 2, is characterized by EIS at different stages of battery cell fabrication. The EIS experiments will yield a Nyquist plot with measured frequency ranging from 10⁶ to 10⁻¹ Hz. The changes in the impedance of battery cells are measured by simulating the EIS data from the Nyquist plots with an equivalent resistance circuit as shown in FIG. 4. Referring to FIG. 4, R_{L} represents the ohmic resistance of the tested cells where the effectiveness and performance of FIS is observed, R_{ct} represents the charge transfer resistance, C_{dl} represents the electrochemical double-layer capacitance, and W represents the Warburg diffusion element that models the diffusion process. The typical result of EIS testing is shown in FIG. 5.

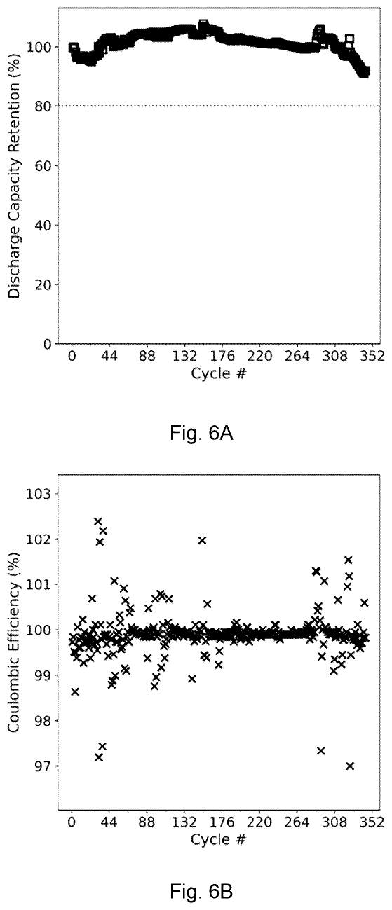

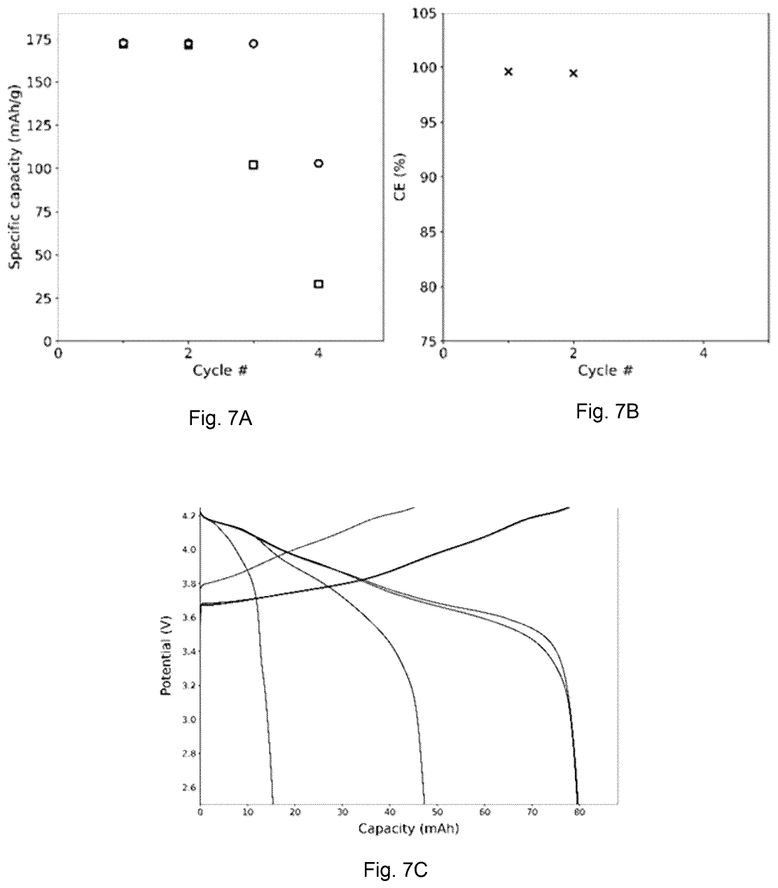

The constructed full battery cells are subsequently evaluated in galvanostatic cycling and rate-capability testing. During the rate-capability test, the full cell is subjected to discharge and charge cycles at various current rates. The discharge current is increased in steps starting from ⅕ C-rate to 2 C-rate, C-rate being a measure of the rate at which a battery is discharged relative to its maximum capacity. The battery's voltage response and specific capacity are monitored during each cycle to evaluate its performance. On the other hand, galvanostatic cycling involves continuously cycling a lithium battery between a defined upper and lower voltage limit at a constant current. During the galvanostatic cycling, the battery cell is cycled in the voltage between 3.0V and 4.2V. This charge-discharge process is repeated multiple times to simulate the battery's typical usage pattern. The key parameters monitored during galvanostatic cycling include the battery's voltage profiles, capacity retention, coulombic efficiency, and impedance changes. The typical results of galvanostatic cycling and rate-capability testing are demonstrated in FIGS. 6A, 6B, 7A-C, 8A-C, 9A-C, 10A, 10B, 11A, 11B, 12A-C, and 13A-C.

The lithium rechargeable battery of the present disclosure may have a variety of shapes which are not specially limited. Examples include a cylindrical can shape, a pouch shape or a coin shape. As described above, the lithium rechargeable battery according to the present disclosure improve the lifetime characteristics of a battery due to improvement in the stability of the SEI and/or CEI, high ion transport capability (both of the FIS liquid phase and its SEI/CEI products), the reduction of battery internal resistance, and the mitigation of electrode crosstalk and other degradation mechanisms.

While the present teachings have been described above in terms of specific embodiments, it is to be understood that they are not limited to these disclosed embodiments. Many modifications and other embodiments will come to mind to those skilled in the art to which this pertains, and which are intended to be and are covered by this disclosure.

As used herein, the term “about” indicates values generally within ±5%, as appropriate (e.g., a lower range limit is −5% and an upper range limit being +5%).

What it is claimed is:

1. A functional interphase stabilizer for a battery comprising:
an organic nonaqueous solvent; and
a lithium salt in solution with the organic nonaqueous solvent.

2. The functional interphase stabilizer according to claim 1, wherein the lithium salt has a concentration in solution of about 0.1M to about 8M.

3. The functional interphase stabilizer according to claim 1, wherein the organic nonaqueous solvent includes at least one of 1,2-Dimethoxy ethane (DME), 1,1,2,2-tetrafluoroethyl-2,2,3,3-tetrafluoropropyl ether (TTE), Dimethyl sulfide (DMS), Fluoroethylene carbonate (FEC), Dimethyl sulfoxide (DMSO), Dimethyl methylphosphonate (DMMPh), Trimethyl phosphate (TMP), Tris(trimethylsilyl) phosphite (TMSPi), Dioxolane (DOL), 1,1-Diethoxy ethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

4. The functional interphase stabilizer according to claim 1, wherein the lithium salt includes at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO₃), Lithium difluoro(oxalato)borate (LiDFOB), Lithium iodide (LiI), Lithium Difluorophosphate (LiPO₂F₂), or Lithium hexafluorophosphate (LiPF₆).

5. A battery comprising:
an anode;
a cathode;
a separator;
a functional interphase stabilizer having an organic nonaqueous solvent; and
a lithium salt in solution with the organic nonaqueous solvent.

6. The battery according to claim 5, wherein the lithium salt has a concentration in solution of about 0.1M to about 8M.

7. The battery according to claim 5, wherein the nonaqueous solvent includes at least one of 1,2-Dimethoxy ethane (DME), 1,1,2,2-tetrafluoroethyl-2,2,3,3-tetrafluoropropyl ether (TTE), Dimethyl sulfide (DMS), Fluoroethylene carbonate (FEC), Dimethyl sulfoxide (DMSO), Dimethyl methylphosphonate (DMMPh), Trimethyl phosphate (TMP), Tris(trimethylsilyl) phosphite (TMSPi), Dioxolane (DOL), 1,1-Diethoxy ethane (DEE), Tetrahydrofuran (THF), Triphenyl phosphate (TPhP), Tris(2,2,2-trifluoroethyl) orthoformate (TFEO), Vinylene carbonate (VC), Triethyl phosphate (TEP), Sulfolane (SL), Methyl 1,1,2,2 Tetrafluoroethyl ether (TFME), or Methyl beta-L-fucopyranoside (MFB), 1,2-(1,1,2,2-Tetrafluoroethoxy)ethane, 1,1,2,2-Tetrafluoroethyl-1H,1H,5H-octafluoropentyl ether, or Acetonitrile.

8. The battery according to claim 5, wherein the lithium salt includes at least one of Lithium bis(trifluoromethanesulfonyl)imide (LiTFSI), Lithium bis(fluoromethanesulfonyl)imide (LiFSI), Lithium fluoride (LiF), Lithium nitrate (LiNO₃), Lithium difluoro(oxalato)borate (LiDFOB), Lithium iodide (LiI), Lithium Difluorophosphate (LiPO₂F₂), or Lithium hexafluorophosphate (LiPF₆).

9. The battery of claim 5, further comprising a solid electrolyte interphase on the anode surface.

10. The battery of claim 9, wherein the solid electrolyte interphase on the anode surface is mechanically adhered to the separator.

11. The battery of claim 5, further comprising a cathode electrolyte interphase on the cathode surface.

12. The battery of claim 11, wherein the cathode electrolyte interphase on the cathode surface is mechanically adhered to the separator.

13. The lithium battery of claim 5, wherein the separator is selected from the group consisting of a polymer membrane or a single- or multi-layered film of polyethylene, polypropylene, polyolefin, a microporous film, ethylene/butene copolymer, ethylene/hexene copolymer, ethylene/methacrylate copolymer, woven fabric, woven fabric with glass fiber, woven fabric with polyethylene terephthalate fiber, cellulose, aramid fiber, another organic or synthetic fiber, ceramic, composite polymer-ceramic solid-state electrolyte, or a combination thereof.

14. The lithium battery of claim 5 wherein the cathode is selected from a group consisting of lithium cobalt-phosphate (LiCoPO₄), lithium iron-phosphate (LiFePO₄), and lithium metal oxide (LiMeOₓ) wherein Me is one or more metal selected from the group consisting of nickel (Ni), cobalt (Co), manganese (Mn) aluminum (Al), Li and O represent one or more respective lithium and oxygen atoms, and x represents the number of oxygen atoms. For example, LiNi_{0.8}Mn_{0.1}Co_{0.1}O₂ (NMC811) is often chosen as a favorable cathode active material. The cathode may also be selected from a group consisting of any other suitable spinel, olivine, sulfide, selenide, halide, or a combination thereof containing or not containing lithium.

15. The lithium battery of claim 5, where in the anode is selected from the group consisting of a carbon-based anode active material, graphitic carbon, carbon fibers, silicon oxide, pure silicon, silicon-carbon composite, a lithium-metal, a lithium alloy, or other suitable anode material or a combination thereof.

16. A method of making a functional interphase stabilizer, comprising:
providing an organic nonaqueous solvent;
adding a lithium salt to the organic nonaqueous solvent; and
mixing the organic nonaqueous solvent and the lithium salt to form a solution.

17. The method of claim 16, further comprising the steps of:
adding an additive to the solution; and
mixing the solution until the additive is dissolved or homogenized.

18. The method of claim 17 wherein the additive is a secondary salt.

19. The method of claim 16, further comprising the steps of:
adding a diluent to the solution; and
mixing the solution until the diluent is homogenized.

20. The method of claim 17 wherein the diluent is a secondary solvent.
